(19) United States
(12) Patent Application Publication
(10) Pub. No.: US 2026/0279641 A1
(43) Pub. Date: Sep. 17, 2026

(54) MAGNETIC INTEGRATED COMPONENT

(71) Applicant: Delta Electronics, Inc., Taoyuan City (TW)

(72) Inventors: HSIN WEI TSAI, Taoyuan City (TW); FAN LIU, Taoyuan City (TW); KAO TSAI LIAO, Taoyuan City (TW)

(21) Appl. No.: 19/281,573

(22) Filed: Jul. 26, 2025

(30) Foreign Application Priority Data
Mar. 13, 2025 (CN) 2025102970570

(51) Int. Cl. H01F 27/22; H01F 27/24; H01F 27/28

(52) U.S. Cl. CPC H01F 27/22; H01F 27/24; H01F 27/28

(57) ABSTRACT

A magnetic integrated component includes: a transformer, a magnetic component, and a heat dissipation material. The transformer has a transformer core. The magnetic component is disposed adjacent to the transformer core, wherein the magnetic component has a coil. The heat dissipation material is arranged between the transformer core and the coil.

### CROSS REFERENCE TO RELATED APPLICATIONS

This application claims priority to Chinese Patent Application No. 2025102970570, filed on Mar. 13, 2025, the entirety of which is incorporated by reference herein.

### FIELD

The disclosure relates to a magnetic integrated component, and more particularly, to a magnetic integrated component including a resonant inductor and a transformer.

### BACKGROUND

Generally, for magnetic components such as transformers, in order to prevent the coil from heating up and causing the efficiency of the magnetic component to deteriorate, the heat is conducted to the outside by contacting the coil with the iron core. However, due to actual assembly considerations and manufacturing tolerances, the core and coil cannot be designed to fit tightly. Therefore, there will be a gap between the coil and the core of the actual transformer product, making it impossible for the coil to fit closely to the core to conduct heat away. The heat generated by magnetic components such as transformers during operation accumulates inside, causing the temperature to rise and lead to magnetic loss. Therefore, there is a need to solve the heat dissipation issue of the above magnetic components.

### SUMMARY

In view of the above, the disclosure provides a magnetic integrated component to effectively solve the issue of heat dissipation of magnetic components in prior art.

In order to achieve the above-mentioned object of the disclosure, one embodiment of the disclosure provides a magnetic integrated component, including: a transformer, a magnetic component, and a heat dissipation material. The transformer includes a transformer core. The magnetic component is disposed adjacent to the transformer core. The magnetic component includes a coil. The heat dissipation material is disposed between the transformer core and the coil.

In one embodiment of the magnetic integrated component, the heat dissipation material is configured to contact the coil in a surface contact manner.

In one embodiment of the magnetic integrated component, the heat dissipation material is configured to directly contact the transformer core.

In one embodiment of the magnetic integrated component, the magnetic component is an inductor including an inductor core, and the inductor core is configured to be disposed beside the transformer core with a gap.

In one embodiment of the magnetic integrated component, the heat dissipation material is disposed in the gap.

In one embodiment of the magnetic integrated component, the heat dissipation material is a heat dissipation pad.

In one embodiment of the magnetic integrated component, the inductor core is E-shaped.

In one embodiment of the magnetic integrated component, the transformer core includes two E-shaped cores disposed corresponding to each other with a transformer gap therebetween.

In one embodiment of the magnetic integrated component, the transformer core includes an E-shaped core and an I-shaped core disposed corresponding to each other with a transformer gap therebetween.

In one embodiment of the magnetic integrated component, the transformer gap is filled with a transformer heat dissipation material.

In comparison with prior art, the heat dissipation material disclosed in the present disclosure is disposed between the transformer core and the coil of the magnetic component, so that the coil of the magnetic component is configured with surface contact with the heat dissipation material, and the heat dissipation material is also configured with surface contact with the transformer core to effectively conduct the heat generated by the coil from inside of the magnetic component and avoid the heat dissipation problem of the magnetic component in the conventional technology. The heat dissipation material also keeps the coil of the magnetic component away from the gap between the inductor core and the transformer core, thereby reducing magnetic loss and fluctuation in inductance readings.

### BRIEF DESCRIPTION OF DRAWINGS

FIG. 1 is a schematic diagram of a three-dimensional structure of a magnetic integrated component according to an embodiment of the present disclosure;

FIG. 2 is a schematic top view of the magnetic integrated component of the embodiment in FIG. 1;

FIG. 3 is a schematic structural diagram of the heat dissipation material, coil, and transformer core configuration of the embodiment in FIG. 1;

FIG. 4 is a top view schematically showing the magnetic integrated component of the embodiment of FIG. 2 after the coil and the heat dissipation material are removed;

FIG. 5 is a front view schematic diagram of the magnetic integrated component of the embodiment of FIG. 1;

FIG. 6 is a schematic cross-sectional view of the magnetic integrated component of FIG. 5 along line AA;

FIG. 7 is a schematic cross-sectional diagram of a magnetic integrated component according to another embodiment; and

FIG. 8 is a schematic cross-sectional view of a magnetic integrated component according to yet another embodiment.

### REFERENCE NUMERALS DESCRIPTION

100, 100a, 100b: magnetic integrated components; 10: transformer; 11, 11a, 11b: transformer core; 12: transformer coil; 13: transformer gap; 14: electrode; 15: insulation material; 20: magnetic components; 21: inductor core; 22: coil; 23: gap; 30: heat dissipation material; 31: transformer heat dissipation material.

### DETAILED DESCRIPTION

In order to make the above and other objects, features, and advantages of the disclosure easier to understand, preferred embodiments of the disclosure will be illustrated below and described in detail with reference to the drawings. In addition, in the drawings, structurally similar units are represented by the same reference numerals.

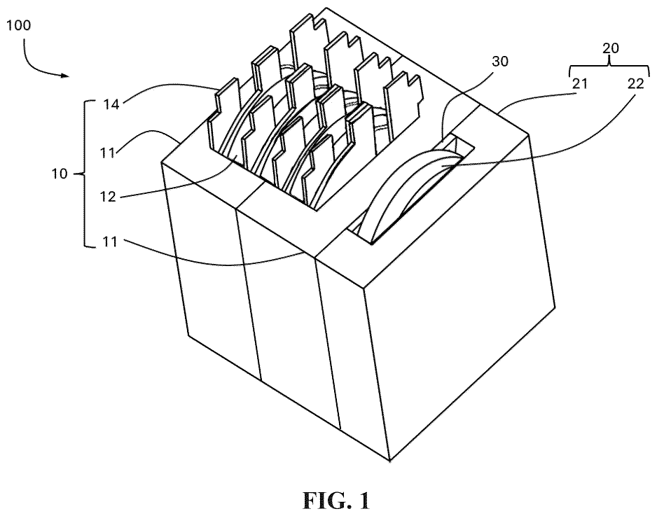

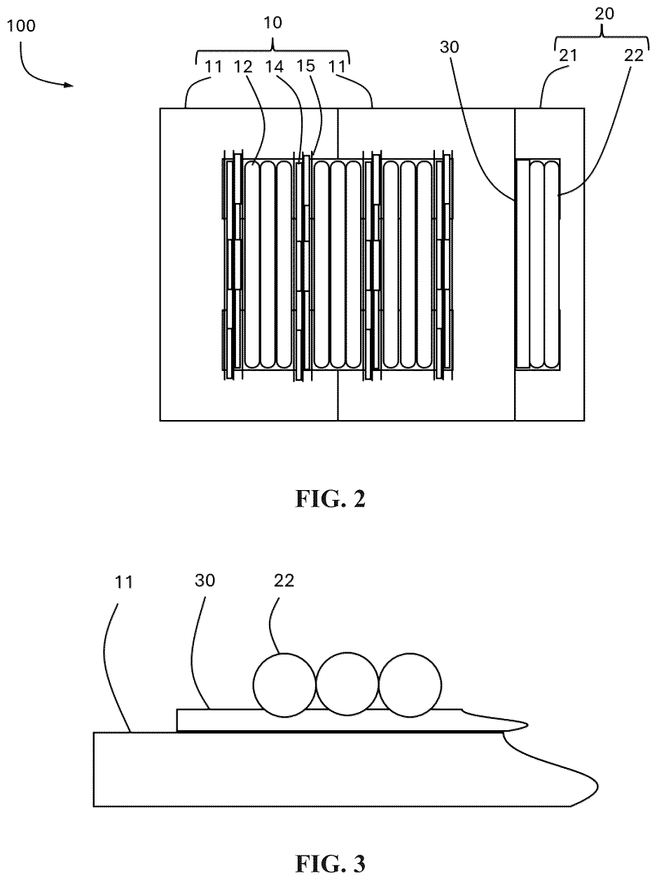

Referring to FIG. 1 and FIG. 2, FIG. 1 is a schematic diagram of a three-dimensional structure of a magnetic integrated component according to an embodiment of the present disclosure. FIG. 2 is a schematic top view of the magnetic integrated component of the embodiment in FIG. 1. The present disclosure provides a magnetic integrated component 100, including: a transformer 10, a magnetic component 20, and a heat dissipation material 30. The transformer 10 includes a transformer core 11. The magnetic component 20 is disposed adjacent to the transformer core 11. The magnetic component 20 includes a coil 22. The heat dissipation material 30 is disposed between the transformer core 11 and the coil 22. In detail, the transformer 10 further includes a plurality of electrodes 14 and an insulation material 15 separating the electrodes 14. In detail, the heat dissipation material 30 disposed between the transformer core 11 and the coil 22 can effectively dissipate the heat generated by the operation of the coil 22 to prevent the heat from accumulating inside and causing the temperature to rise and thus causing magnetic loss.

Referring to FIG. 3, FIG. 3 is a schematic structural diagram of the heat dissipation material, coil, and transformer core configuration of the embodiment in FIG. 1. In one embodiment of the present disclosure, the heat dissipation material 30 is configured to be in surface contact with the coil 22. In the prior art, the wire of the coil 22 generally has a circular cross-section, and the only contact with a plane is at the tangent point of the circle so as to form a point contact, which is not conducive to heat conduction. As shown in FIG. 3, the heat dissipation material 30 of this embodiment is partially deformed due to assembly extrusion to partially cover a curved surface of the coil 22, forming surface contact with the curved surface of the coil 22 to expand the heat dissipation area of the coil.

Referring to FIG. 3, in one embodiment of the present disclosure, the heat dissipation material 30 is configured to be in direct contact with the transformer core 11. Therefore, the heat generated by the coil 22 during operation can be better conducted to the transformer core 11 through the heat dissipation material 30 and then to the outside of the magnetic integrated component 100, thereby effectively reducing the heat generated inside the coil.

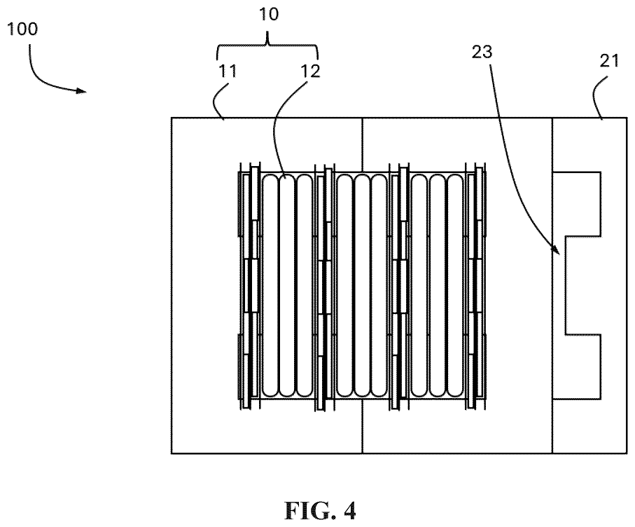

Referring to FIG. 4, FIG. 4 is a top view schematically showing the magnetic integrated component of the embodiment of FIG. 2 after the coil and the heat dissipation material are removed. In one embodiment of the present disclosure, the magnetic component 20 is an inductor having an inductor core 21, and the inductor core 21 is configured to be disposed to the transformer core 11 with a gap 23 (the inductor core 21 is an E-shaped core, and the gap 23 is located between the center column of the inductor core 21 and the transformer core 11). In detail, the magnetic component 20 is a resonant inductor. In detail, when there is an air gap in the iron core, since the magnetic permeability of air is much lower than that of the iron core to increase the magnetic resistance, cause its magnetic permeability to decrease and the remanent magnetism to decrease, the magnetomotive force will stay (consume) in the air gap. The maximum magnetic flux density Bm can reach the saturation magnetic flux density Bs, thereby increasing the magnetic flux increment and making the iron core less likely to be magnetically saturated.

Referring to FIG. 2 and FIG. 4 together, in one embodiment of the present disclosure, the heat dissipation material 30 is disposed in the gap 23. In detail, the coil 22 is preferably disposed at a position of the iron core (ex: the center column of the inductor core 21). If the coil 22 is disposed at the gap 23, magnetic loss will be caused. Therefore, when the heat dissipation material 30 is configured in the gap 23, in addition to improving the heat dissipation effect of the coil 22, the coil 22 can also be pushed away from the gap 23 to avoid factors such as tolerance consideration that cause the coil 22 to be close to the gap 23 after the magnetic integrated component 100 is assembled, thereby reducing the electromagnetic loss caused by the gap 23 to the coil 22 and the fluctuation of the inductance reading. In detail, the heat dissipation material 30 can be configured at any position between the coil 22 and the transformer core 11 or the inductor core 21 to produce a heat dissipation effect, but this configuration cannot push the coil 22 to the gap 23 to prevent the gap 23 from causing electromagnetic loss to the coil 22 and fluctuation in the inductance reading. Therefore, it is preferred that the heat dissipation material 30 is disposed in the gap 23 between the inductor core 21 and the transformer core 11.

In one embodiment of the present disclosure, the heat dissipation material 30 is a heat dissipation pad. In detail, the heat dissipation material 30 can be heat dissipation paste, heat dissipation glue, heat dissipation mud, heat dissipation silicone or heat dissipation clay, which can locally deform to partially cover the curved surface of the coil 22 and form surface contact with the surface of the coil 22 to expand the heat dissipation area of the coil. At the same time, heat dissipation material 30 contacts the surface of the transformer core 11, and a sheet-shaped heat dissipation pad is formed between the surface of the coil 22 and the surface of the transformer core 11. In detail, since the method of filling colloidal heat dissipation material into the gap 23 from outside of the magnetic integrated component 100 may form an unfilled area, resulting in uneven distribution of the heat dissipation material and causing local high temperature and deterioration of the coil. Therefore, a better method is to first form the heat dissipation material into a sheet and attach it to the surface of the coil 22 or the surface of the transformer core 11. And then combine the magnetic component 20 with the transformer 10. In detail, the heat dissipation paste (as known as thermal conductive paste) is composed of, for example, a polymer compound, a high thermal conductive metal oxide, and a metal powder and is suitable for filling tiny gaps in components. The heat dissipation glue (as known as thermal conductive adhesive) includes, for example, an epoxy resin base and metal particles such as iron, silver, and nickel. There are also heat sinks made of silicone rubber, glass fiber, polyester base material, and silicone oil on the market.

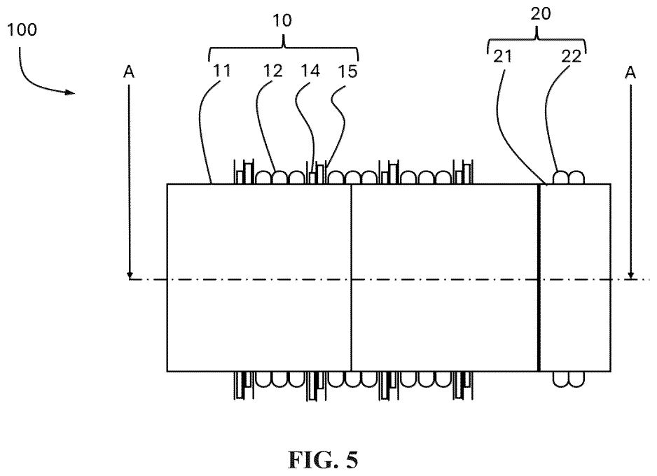

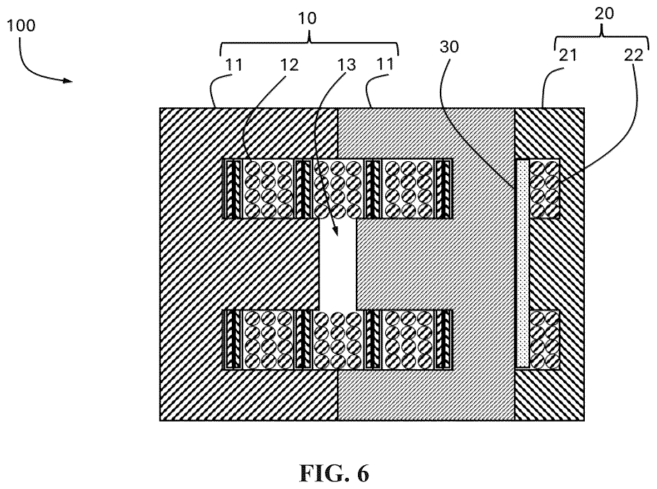

Referring to FIG. 5 and FIG. 6, FIG. 5 is a front view schematic diagram of the magnetic integrated component of the embodiment of FIG. 1. FIG. 6 is a schematic cross-sectional view of the magnetic integrated component of FIG. 5 along line AA. In one embodiment of the present disclosure, the inductor core 21 is E-shaped. In detail, the space in the middle of the E-shaped inductor core 21 is used to wind the coil 22. The inductor core 21 is used to increase the magnetic flux of the coil 22.

Referring to FIG. 6, in one embodiment of the present disclosure, the transformer core 11 includes two E-shaped cores disposed opposite to each other, and a transformer gap 13 is defined between the two E-shaped cores (the transformer gap 13 is located between the middle columns of the two E-shaped cores). The transformer gap 13 is similar to the above-mentioned gap 23, and please refer to the above description, which will not be repeated here.

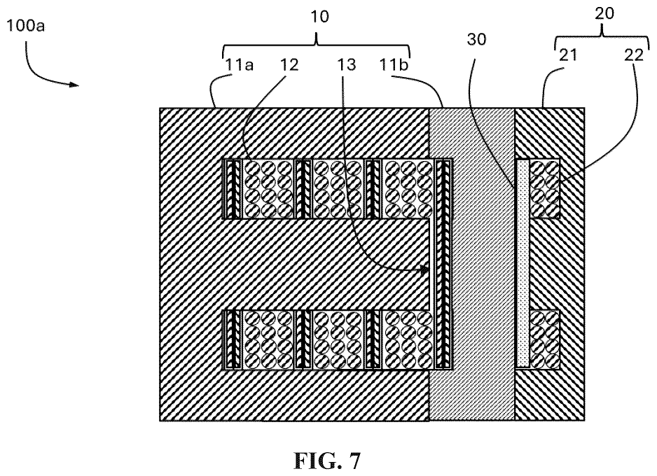

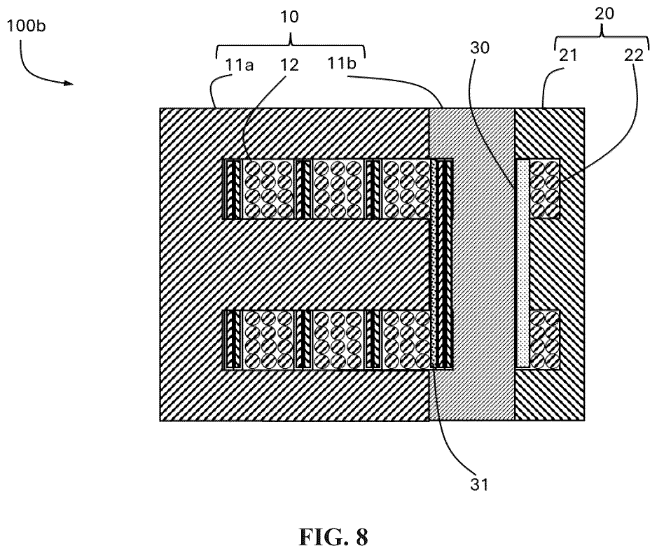

Referring to FIG. 7, FIG. 7 is a schematic cross-sectional diagram of a magnetic integrated component according to another embodiment. In one embodiment of the present disclosure, the transformer core includes an E-shaped core 11a and an I-shaped core 11b arranged opposite to each other, and a transformer gap 13 is defined between the E-shaped core 11a and the I-shaped core 11b (the transformer gap 13 is located between the center column of the E-shaped core 11a and the I-shaped core 11b). The transformer gap 13 is similar to the above-mentioned gap 23, and please refer to the above description, which will not be repeated here.

Referring to FIG. 8, FIG. 8 is a schematic cross-sectional view of a magnetic integrated component according to yet another embodiment. In one embodiment of the present disclosure, a transformer heat dissipation material 31 is disposed in the transformer gap 13. In detail, it is not easy to set heat dissipation materials on general transformers because the standard requirements of the transformer heat dissipation material 31 are relatively high, requiring high insulation properties and high heat resistance, while not significantly affecting the magnetic permeability of the transformer. In detail, similar to the description of the gap 23 and the heat dissipation material 30 above, the transformer heat dissipation material 31 is disposed in the transformer gap 13, so the transformer coil 12 can be pushed away from the transformer gap 13 to avoid the transformer gap 13 causing electromagnetic loss and fluctuation in inductance readings to the transformer coil 12.

In comparison with prior art, the heat dissipation material disclosed in the present disclosure is disposed between the transformer core and the coil of the magnetic component, so that the coil of the magnetic component is configured with surface contact with the heat dissipation material, and the heat dissipation material is also configured with surface contact with the transformer core to effectively conduct the heat generated by the coil from inside of the magnetic component and avoid the heat dissipation problem of the magnetic component in the conventional technology. The heat dissipation material also keeps the coil of the magnetic component away from the gap between the inductor core and the transformer core, thereby reducing magnetic loss and fluctuation in inductance readings.

The above description is to illustrate the characteristics of the disclosure through preferred embodiments. The purpose is to enable those skilled in the art to understand the content of the disclosure and implement it accordingly, but not to limit the patent scope of the application. Therefore, any other equivalent modifications or modifications that do not depart from the technical ideas disclosed in this application shall still be included in the claim scope described below.

What is claimed is:

1. A magnetic integrated component, comprising:
a transformer comprising a transformer core;
a magnetic component disposed adjacent to the transformer core, wherein the magnetic component comprises a coil; and
a heat dissipation material disposed between the transformer core and the coil.

2. The magnetic integrated component of claim 1, wherein the heat dissipation material is configured to contact the coil in a surface contact manner.

3. The magnetic integrated component of claim 1, wherein the heat dissipation material is configured to directly contact the transformer core.

4. The magnetic integrated component of claim 1, wherein the magnetic component is an inductor comprising an inductor core, and the inductor core is configured to be disposed beside the transformer core with a gap.

5. The magnetic integrated component of claim 4, wherein the heat dissipation material is disposed in the gap.

6. The magnetic integrated component of claim 5, wherein the heat dissipation material is a heat dissipation pad.

7. The magnetic integrated component of claim 5, wherein the inductor core is E-shaped.

8. The magnetic integrated component of claim 4, wherein the transformer core comprises two E-shaped cores disposed corresponding to each other with a transformer gap therebetween.

9. The magnetic integrated component of claim 4, wherein the transformer core comprises an E-shaped core and an I-shaped core disposed corresponding to each other with a transformer gap therebetween.

10. The magnetic integrated component of claim 9, wherein the transformer gap is filled with a transformer heat dissipating material.
